(19) United States
(12) Patent Application Publication
(10) Pub. No.: US 2025/0100294 A1
(43) Pub. Date: Mar. 27, 2025

(54) INK-JET PRINTING APPARATUS AND INK DEAERATION METHOD

(71) Applicant: SCREEN Holdings Co., Ltd., Kyoto (JP)

(72) Inventors: Yusuke AKIYAMA, Kyoto-shi (JP); Tadayoshi SUYAMA, Kyoto-shi (JP); Kazuhiko ASADA, Kyoto-shi (JP)

(21) Appl. No.: 18/887,322

(22) Filed: Sep. 17, 2024

(30) Foreign Application Priority Data
Sep. 22, 2023 (JP) 2023-158952

(51) Int. Cl. B41J 2/19; B41J 2/175; B41J 2/185

(52) U.S. Cl. CPC B41J 2/19; B41J 2/17596; B41J 2/185; B41J 2202/07

(57) ABSTRACT

A deaeration module is arranged in a return pipe for returning an ink from a collection tank to a supply tank, and this deaeration module removes a gas from the ink, which flows in the pipe. The deaeration module is arranged in the pipe for replenishing the ink from a buffer tank to the collection tank, and this deaeration module removes the gas from the ink flowing in the pipe.

### CROSS REFERENCE TO RELATED APPLICATION

The disclosure of Japanese Patent Application No. 2023-158952 filed on Sep. 22, 2023 including specification, drawings and claims is incorporated herein by reference in its entirety.

### BACKGROUND OF THE INVENTION

### 1. Field of the Invention

This invention relates to a deaeration technique for deaerating a gas from an ink supplied to a discharge head for discharging the ink from nozzles.

### 2. Description of the Related Art

An ink-jet printing apparatus is known which prints an image by discharging an ink from nozzles by an ink-jet method. In such an ink-jet printing apparatus, it is important to suppress the quantity of a gas to be mixed into the ink (dissolved oxygen quantity) to satisfactorily discharge the ink from the nozzles. In contrast, an ink-jet printing apparatus of JP 2014-233952A removes a gas from an ink using two deaeration modules.

Incidentally, in this ink-jet printing apparatus, four tanks are used to supply the ink to a head (discharge head). Specifically, the ink stored in an ink tank is supplied to the head via a supply sub tank, and the ink collected into a collection sub tank from the head is returned to the ink tank. In this way, the ink is circulated between the ink tank and the head. Further, a main tank for storing a large quantity of the ink is provided, and the ink is replenished from the main tank to the ink tank. The deaeration module is provided between the main tank and the ink tank, and the deaeration module is provided between the ink tank and the supply sub tank.

### SUMMARY OF THE INVENTION

However, the arrangement of the deaeration modules as described above cannot necessarily be said to be proper and the quantity of the gas mixed into the ink to be supplied to the discharge head could not be sufficiently suppressed. In such cases, it is difficult to maintain satisfactory discharge of the ink from the discharge head.

This invention was developed in view of the above problem and aims to enable the discharge of an ink from a discharge head to be satisfactorily maintained by properly arranging a deaeration module to suppress the quantity of a gas mixed into the ink to be supplied to the discharge head.

An ink-jet printing apparatus according to the invention, comprises: a head unit including a discharge head discharging an ink from nozzles; a supply tank supplying the ink to the discharge head; a collection tank collecting the ink from the discharge head; an ink returner including a return flow channel connecting the collection tank and the supply tank, the ink returner returning the ink from the collection tank to the supply tank by the return flow channel; an ink tank storing the ink; and an ink replenisher including a replenishment flow channel connecting the ink tank and the collection tank, the ink replenisher replenishing the ink from the ink tank to the collection tank by the replenishment flow channel, the ink returner including a first deaeration unit arranged in the return flow channel, the first deaeration unit removing a gas from the ink flowing in the return flow channel, the ink replenisher including a second deaeration unit arranged in the replenishment flow channel, and the second deaeration unit removing the gas from the ink flowing the replenishment flow channel.

An ink deaeration method according to the invention, comprises: supplying an ink from a supply tank to a discharge head discharging the ink from nozzles; collecting the ink from the discharge head to the collection tank; returning the ink from the collection tank to the supply tank by a return flow channel connecting the collection tank and the supply tank; replenishing the ink from the ink tank to the collection tank by a replenishment flow channel connecting the ink tank and the collection tank, a first deaeration unit being arranged in the return flow channel, the first deaeration unit removing a gas from the ink flowing in the return flow channel, a second deaeration unit being arranged in the replenishment flow channel, and the second deaeration unit removing the gas from the ink flowing in the replenishment flow channel.

In the invention (ink-jet printing apparatus, ink deaeration method) thus configured, the discharge head discharges the ink supplied from the supply tank. Accordingly, to maintain the discharge of the ink from the discharge head satisfactory, it is important to sufficiently suppress the quantity of the gas mixed in the ink in the supply tank serving as a supply source of the ink to the discharge head. On the other hand, the ink is supplied to the supply tank via the collection tank, whereas the gas having entered from the discharge head via the nozzles is easily mixed into the ink in the collection tank. Thus, the invention includes the first deaeration unit arranged in the return flow channel for returning the ink from the collection tank to the supply tank, and this first deaeration unit removes the gas from the ink flowing in the return flow channel. In this way, the gas is removed from the ink flowing out from the collection tank toward the supply tank. Further, the invention includes the second deaeration unit arranged in the replenishment flow channel for replenishing the ink from the ink tank to the collection tank, and this second deaeration unit removes the gas from the ink flowing in the replenishment flow channel. In this way, the gas is removed from the ink flowing toward the collection tank. That is, in the invention, the deaeration unit is provided for each of the entrance and exit of the collection tank through which the ink flows toward the supply tank. As a result, the discharge of the ink from the discharge head can be maintained satisfactory by sufficiently suppressing the quantity of the gas mixed in the ink in the supply tank serving as the supply source of the ink to the discharge head.

As described above, according to the invention, it is possible to satisfactorily maintain the discharge of an ink from a discharge head by properly arranging a deaeration module to suppress the quantity of a gas mixed into the ink to be supplied to the discharge head. The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a front view schematically showing an example of an ink-jet printing apparatus according to the invention.

FIG. 2 is a bottom view schematically showing the configuration of the head unit.

FIG. 3 is a sectional view schematically showing the internal configuration of the discharge head.

FIG. 4 is a diagram schematically showing an ink circulating/supplying mechanism for circulating and supplying the ink to the discharge heads of the head unit.

FIG. 5 is an overall perspective view of the ink-jet printing apparatus showing a positional relationship of the head units and the ink returners provided for these head units.

FIG. 6 is a partial perspective view showing the ink returner.

FIG. 7 is a table showing an example of an experimental result on a relationship of the arrangement of the deaeration modules and a dissolved oxygen concentration in the ink returner.

### DETAILED DESCRIPTION OF THE PREFERRED EMBODIMENTS

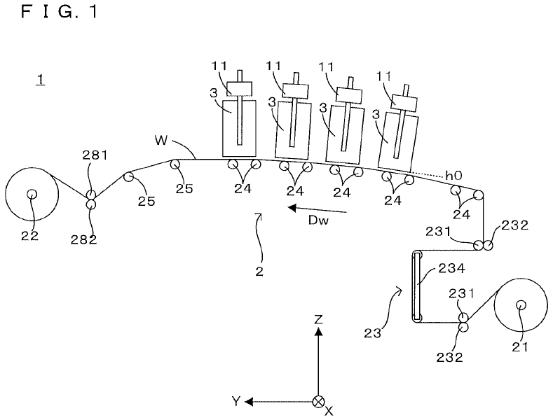

FIG. 1 is a front view schematically showing an example of an ink-jet printing apparatus according to the invention. In this specification, an X direction, which is a horizontal direction, a Y direction, which is a horizontal direction orthogonal to the X direction, and a Z direction, which is a vertical direction, are appropriately shown. The ink-jet printing apparatus 1 prints an image on a web W by discharging inks to the web W by an ink-jet method while conveying the web W in the form of a long strip in a roll-to-roll manner. The web W is made of paper or film and is flexible.

The ink-jet printing apparatus 1 is provided with a conveyor 2 for conveying the web 10 in a web conveying direction Dw. The conveyor 2 includes a feeding roller 21 and a winding roller 22, and conveys the web W in a roll-to-roll manner by winding the web W fed by the feeding roller 21 by the winding roller 22. This conveyor 2 is provided with a take-in part 23 for taking in the web W fed from the feeding roller 21 between the feeding roller 21 and the winding roller 22. The take-in part 23 includes two drive rollers 231, two nip rollers 232 and an edge position adjuster 234 provided between the two drive rollers 231. Each drive roller 231 drives the web W by being rotated by a drive force of a motor while the web W is wound thereon. The two nip rollers 232 are respectively provided to correspond to the two drive rollers 231, and the web W is sandwiched between the respective nip rollers 232 and the corresponding drive rollers 231. The edge position adjuster 234 adjusts end positions of the web W in the X direction, which is a width direction of the web W.

Further, the conveyor 2 includes a plurality of support rollers 24 for supporting the web W between the take-in part 23 and the winding roller 22. These support rollers 24 convey the web W in the Y direction while supporting the web W, to which the inks are discharged by the ink-jet method, from below. Particularly, the plurality of support rollers 24 are obliquely arrayed so that the support roller 24 on a more downstream side in the conveying direction of the web W (Y direction) is located at a higher position. Therefore, the web W conveyed by these support rollers 24 is obliquely conveyed to be elevated as moving in the Y direction. Further, the conveyor 2 includes a plurality of support rollers 25 for supporting the web W between these support rollers 24 and the winding roller 22 and a drive roller 281 and a nip roller 282 arranged between these support rollers 25 and the winding roller 22. The drive roller 281 drives the web W by being rotated by a drive force of a motor while winding the web W thereon. The web W is sandwiched between the nip roller 282 and the drive roller 281.

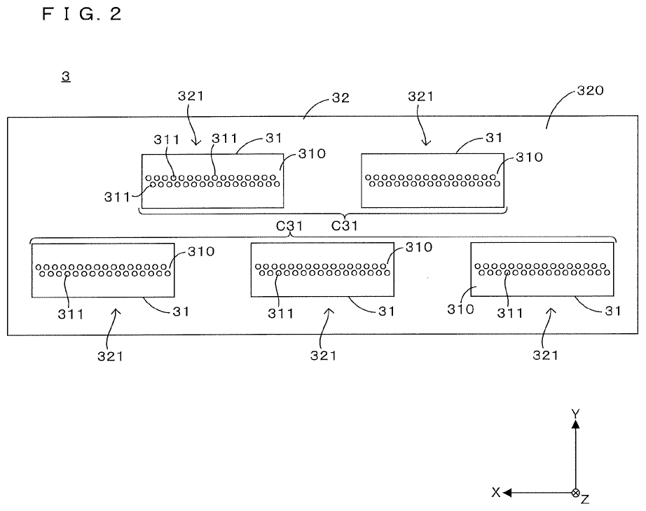

The ink-jet printing apparatus 1 includes a plurality of (four) head units 3 (see FIG. 2) facing the web W, supported by the plurality of support rollers 24, from above. The plurality of head units 3 respectively discharge mutually different color inks, specifically inks of yellow, magenta, cyan and black, to the web W being conveyed by the conveyor 2 by the ink-jet method. Note that the number of the head units 3 and the colors of the inks are not limited to the examples here. Further, UV inks, water-based inks or the like can be used as the inks to be discharged by the head units 3.

As shown in FIG. 1, the posture of each of the plurality of head units 3 is set according to the inclination of the web W supported by the plurality of support rollers 24. That is, the respective head units 3 are so arranged that, out of the plurality of head units 3, the head unit 3 on a more upstream side in the conveying direction of the web W is more inclined to the Z direction. However, the head unit 3 on a most downstream side in the conveying direction (Y direction) of the web W is horizontally arranged and not inclined to the Z direction, and the head units 3 other than the most upstream one are inclined to be higher in the conveying direction of the web W. Note that the inclination of the head unit 3 can be evaluated by an angle of nozzle open flat surfaces 310 of discharge heads 31, nozzle open flat surfaces 310 being formed with nozzles 311.

Further, the ink-jet printing apparatus 1 is provided with a plurality of elevation drivers 11 respectively provided to correspond to the plurality of head units 3. Each elevation driver 11 can position the head unit 3 at any one of a plurality of positions having mutually different heights by elevating or lowering the corresponding head unit 3. In FIG. 1, each head unit 3 is located at a height h0 closest to the web W. Such an elevation driver 11 can be realized by a known specific configuration and, for example, configured to elevate and lower the head unit 3 by driving a ball screw, an eccentric cam or the like by a motor.

FIG. 2 is a bottom view schematically showing the configuration of the head unit. Each head unit 3 includes a plurality of (five) discharge heads 31. The plurality of discharge heads 31 are arranged at mutually different positions in the X direction and arrayed in two rows in the X direction in a staggered manner. In other words, a head row C31 composed of three discharge heads 31 arrayed in parallel to the X direction and a head row C31 composed of two discharge heads 31 arrayed in parallel to the X direction are provided in the Y direction. The bottom surface of each discharge head 31 is the nozzle open flat surface 310 facing the web W, and the nozzle open flat surface 310 has a rectangular shape in a bottom view. A plurality of the nozzles 311 are open in the nozzle open flat surface 310. The plurality of nozzles 311 are arrayed in the X direction in a staggered manner and face the web W from above, and each nozzle 311 discharges the ink to the web W by the ink-jet method.

This head unit 3 includes a head holding member 32 for holding the respective discharge heads 31. The bottom surface of the head holding member 32 is a web facing flat surface 320 facing the web W, and the web facing flat surface 320 has a rectangular shape in a bottom view. A plurality of head insertion holes 321 provided to correspond to the plurality of discharge heads 31 are open in the web facing flat surface 320. The plurality of discharge heads 31 are fixed to the head holding member 32 while being respectively inserted in the corresponding head insertion holes 321. Such a head holding member 32 can be made of a non-elastic material such as metal or resin.

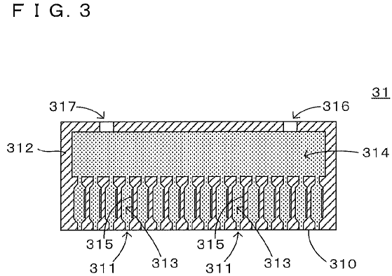

FIG. 3 is a sectional view schematically showing the internal configuration of the discharge head. As shown in FIG. 3, the discharge head 31 includes a housing 312. In the nozzle open flat surface 310 provided on the bottom surface of the housing 312, the plurality of nozzles 311 are open and arrayed in the Y direction in a staggered manner as described above. A plurality of cavities 313 respectively communicating with the plurality of nozzles 311 and an ink supply chamber 314 communicating with the plurality of cavities 313 are provided inside the housing 312, and the ink supplied from the ink supply chamber 314 is stored in the cavities 313. Further, a piezoelectric element 315 is provided in each cavity 313, and a pressure variation is given to the ink in the cavity 313 by a displacement of the piezoelectric element 315 according to a drive signal (electrical signal). By this pressure variation, the ink is pushed out from the cavity 313 and discharged from the nozzle 311 communicating with this cavity 313. Further, an ink inflow port 316 and an ink outflow port 317 are respectively open in an upper part of the discharge head 31, and the ink flows into the ink supply chamber 314 from outside via the ink inflow port 316 and flows out to outside from the ink supply chamber 314 via the ink outflow port 317.

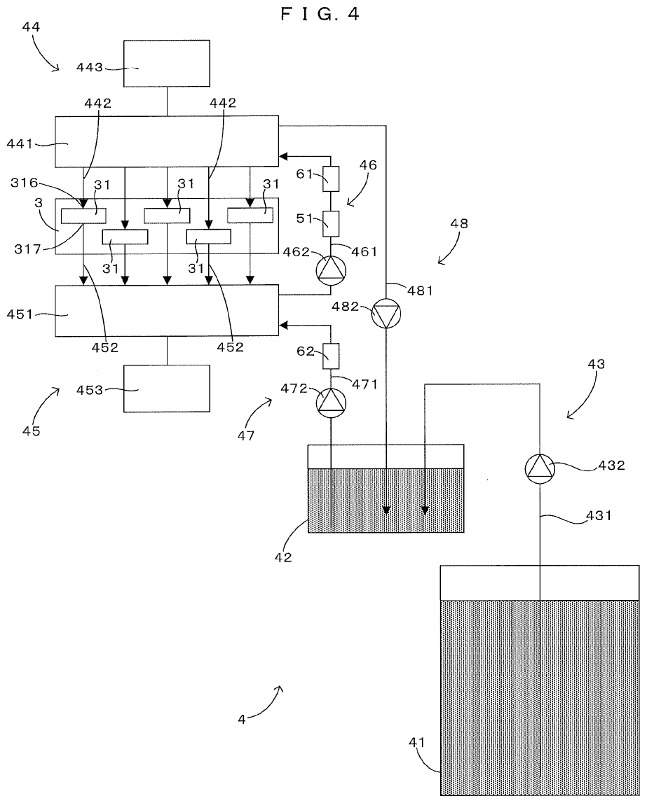

FIG. 4 is a diagram schematically showing an ink circulating/supplying mechanism for circulating and supplying the ink to the discharge heads of the head unit. In the ink-jet printing apparatus 1, a plurality of the ink circulating/supplying mechanisms 4 respectively corresponding to the plurality of head units 3 are provided. That is, one ink circulating/supplying mechanism 4 is provided for each head unit 3.

The ink circulating/supplying mechanism 4 includes a main tank 41 and a buffer tank 42 respectively for storing the ink. A volume of the ink storable in the buffer tank 42 is smaller than that of the ink storable in the main tank 41. Since a deaeration processing is not applied to the ink in the buffer tank 42, there is a possibility that a mixed gas quantity is large. Further, the ink circulating/supplying mechanism 4 includes a main replenisher 43 for replenishing the ink from the main tank 41 to the buffer tank 42. The main replenisher 43 includes a pipe 431 connecting the main tank 41 and the buffer tank 42, and the main tank 41 and the buffer tank 42 communicate with each other via the pipe 431. Further, the ink circulating/supplying mechanism 4 includes a main pump 432 mounted to the pipe 431 between the main tank 41 and the buffer tank 42. The ink is replenished from the main tank 41 to the buffer tank 42 by the main pump 432 driving the ink in the pipe 431 from the main tank 41 to the buffer tank 42.

Further, the ink circulating/supplying mechanism 4 includes an ink supplier 44 for supplying the ink to each discharge head 31 of the head unit 3. The ink supplier 44 includes a supply tank 441 for storing the ink to be supplied to each discharge head 31 and a plurality of pipes 442 respectively connecting the supply tank 441 and the plurality of discharge heads 31, and the supply tank 441 and the discharge head 31 communicate with each other via the pipe 442. Accordingly, the ink flowing out from the supply tank 441 flows into the discharge head 31 through the pipe 442. More particularly, the ink flowing out from the supply tank 441 to the pipe 442 flows into the ink supply chamber 314 via the ink inflow port 316. Further, the ink supplier 44 includes a pressure adjuster 443 for adjusting a pressure in the supply tank 441, and the pressure adjuster 443 applies a predetermined pressure P44 (negative pressure) to the ink (specifically, a gas-liquid interface in the supply tank 441) stored in the supply tank 441.

Further, the ink circulating/supplying mechanism 4 includes an ink collector 45 for collecting the ink from each discharge head 31 of the head unit 3. The ink collector 45 includes a collection tank 451 for storing the ink collected from each discharge head 31 and a plurality of pipes 452 respectively connecting the plurality of discharge heads 31 and the collection tank 451, and the discharge head 31 and the collection tank 451 communicate with each other through the pipe 452. Thus, the ink flowing out from the discharge head 31 flows into the collection tank 451 through the pipe 452. More particularly, the ink flowing out from the ink supply chamber 314 to the pipe 452 via the ink outflow port 317 flows into the collection tank 451. Furthermore, the ink collector 45 includes a pressure adjuster 453 for adjusting a pressure in the collection tank 451, and the pressure adjuster 453 applies a predetermined pressure P45 (negative pressure) to the ink (specifically, a gas-liquid interface in the collection tank 451) stored in the collection tank 451.

At this time, the pressure P45 applied to the ink in the collection tank 451 is lower than the pressure P44 applied to the ink in the supply tank 441. A flow of the ink from the supply tank 441 toward the collection tank 451 via the discharge heads 31 is formed by this pressure difference (P44-P45).

Further, the ink circulating/supplying mechanism 4 includes an ink returner 46 for returning the ink flowing into the collection tank 451 to the supply tank 441. The ink returner 46 includes a pipe 461 connecting the collection tank 451 and the supply tank 441, and the collection tank 451 and the supply tank 441 communicate with each other via the pipe 461. Further, the ink returner 46 includes a circulation pump 462 mounted to the pipe 461 between the collection tank 451 and the supply tank 441. The ink is returned from the collection tank 451 to the supply tank 441 via the pipe 461 by the circulation pump 462, which drives the ink in the pipe 461 from the collection tank 451 to the supply tank 441.

In this way, in the ink circulating/supplying mechanism 4, an ink circulation path is formed to return the ink flowing into the collection tank 451 from the supply tank 441 via the discharge heads 31 to the supply tank 441 by the ink returner 46. The discharge heads 31 discharge the ink supplied via the circulation path.

Further, the ink returner 46 includes a filter 51 mounted to the pipe 461 between the circulation pump 462 and the supply tank 441. This filter 51 removes foreign matters from the ink in the pipe 461. That is, the filter 51 removes foreign matters from the ink passing through the filter 51 from the collection tank 451 toward the supply tank 441 along the pipe 461.

Furthermore, the ink returner 46 includes a deaeration module 61 mounted to the pipe 461 between the filter 51 and the supply tank 441. This deaeration module 61 removes a gas from the ink in the pipe 461. That is, the deaeration module 61 removes the gas from the ink passing through the deaeration module 61 from the collection tank 451 toward the supply tank 441 along the pipe 461. This deaeration module 61 removes the gas from the ink by applying a negative pressure generated by a vacuum pump to the ink via a hollow fiber membrane. Further, in a flow of the ink from the collection tank 451 toward the supply tank 441, the deaeration module 61 is located downstream of the filter 51. Therefore, the deaeration module 61 removes the gas from the ink having the foreign matters removed by the filter 51.

Further, the ink circulating/supplying mechanism 4 includes an ink replenisher 47 for replenishing the ink from the buffer tank 42 to the collection tank 451. The ink replenisher 47 includes a pipe 471 connecting the buffer tank 42 and the collection tank 451, and the buffer tank 42 and the collection tank 451 communicate with each other via the pipe 471. Further, the ink replenisher 47 includes a replenishing pump 472 mounted to the pipe 471 between the buffer tank 42 and the collection tank 451. The ink is replenished from the buffer tank 42 to the collection tank 451 by the replenishing pump 472, which drives the ink in the pipe 471 from the buffer tank 42 to the collection tank 451.

Furthermore, the ink replenisher 47 includes a deaeration module 62 mounted to the pipe 471 between the replenishing pump 472 and the collection tank 451. This deaeration module 62 removes the gas from the ink in the pipe 471. That is, the deaeration module 62 removes the gas from the ink passing through the deaeration module 62 from the buffer tank 42 toward the collection tank 451 along the pipe 471. This deaeration module 62 removes the gas from the ink by applying a negative pressure generated by a vacuum pump to the ink via a hollow fiber membrane.

Further, the ink circulating/supplying mechanism 4 includes an ink returner 48 for returning the ink from the supply tank 441 to the buffer tank 42. The ink returner 48 includes a pipe 481 connecting the supply tank 441 and the buffer tank 42, and the supply tank 441 and the buffer tank 42 communicate with each other via the pipe 481. Further, the ink returner 48 includes a return pump 482 mounted to the pipe 481 between the supply tank 441 and the buffer tank 42. The ink is returned from the supply tank 441 to the buffer tank 42 by the return pump 482, which drives the ink in the pipe 481 from the supply tank 441 to the buffer tank 42.

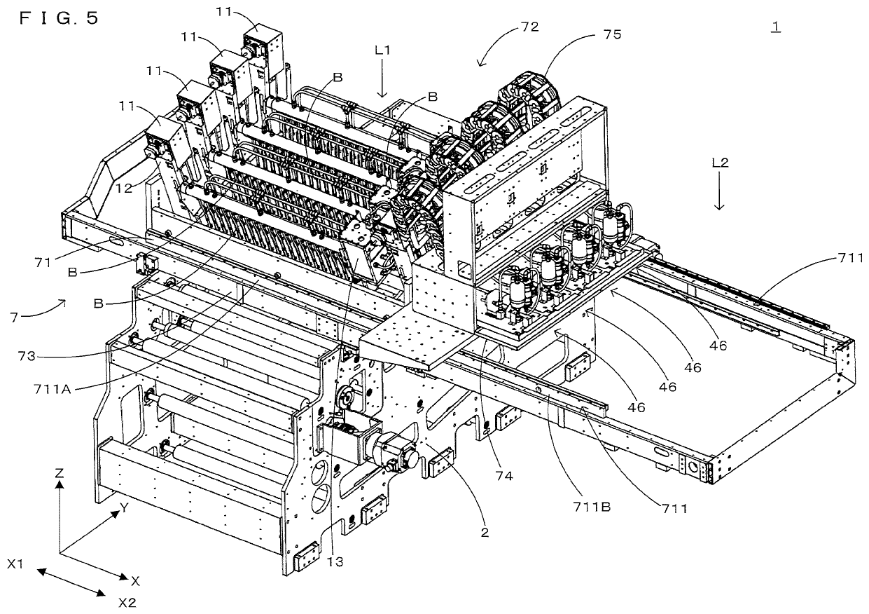

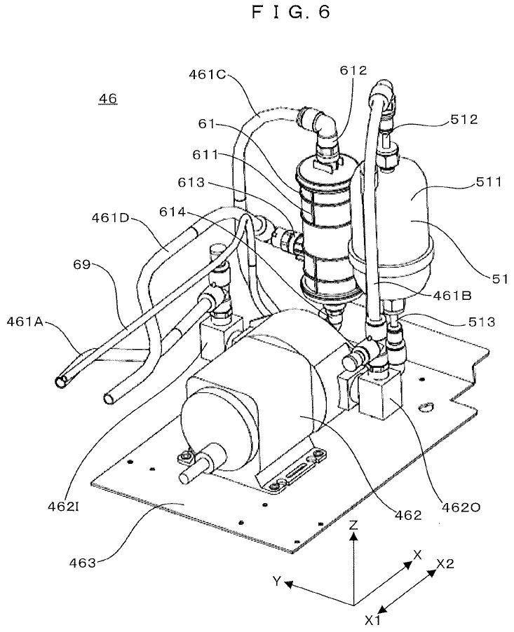

Note that, out of the ink circulating/supplying mechanism 4, the ink returner 46 arranged close to the head unit 3 is configured to move integrally with the head unit 3. Next, this point is described using FIGS. 5 and 6.

FIG. 5 is an overall perspective view of the ink-jet printing apparatus showing a positional relationship of the head units and the ink returners provided for these head units, and FIG. 6 is a partial perspective view showing the ink returner.

As shown in FIG. 5, the ink-jet printing apparatus 1 includes a moving/holding mechanism 7 provided above the conveyor 2. This moving/holding member 7 includes a guiding part 71 mounted on the upper end of the conveyor 2 and a holding unit 72 to be guided by the guiding part 71, and the guiding part 71 guides a movement of the holding unit 72 in the X direction. The guiding part 71 includes a pair of guiding rails 711 spaced apart in the Y direction. The respective guiding rails 711 extend in parallel to the X direction, parts 711A on one side X1 of the respective guiding rails 711 are facing the conveyor 2 in the Z direction, whereas parts 711B on the other side X2 of the guiding rails 711 project in the X direction from the conveyor 2 and are not facing the conveyor 2 in the Z direction.

The holding unit 72 moves in the X direction along the pair of guiding rails 711 while being engaged with the guiding rails 711. This holding unit 72 includes a holding frame 73 and a holding frame 74 provided on the other side X2 in the X direction of the holding frame 73. The holding frame 73 and the holding frame 74 are fixed to each other and integrally configured.

The holding frame 73 holds a plurality of (four) print bars B corresponding to the inks of the mutually different colors. This print bar B is a unit formed by integrally configuring the head unit 3 and the supply tank 441, the pipe 442, the collection tank 451 and the pipe 452 corresponding to this head unit 3. Further, the holding frame 73 holds the elevation driver 11 for elevating and lowering the print bar B. That is, the elevation driver 11 elevates and lowers the head unit 3 included in the print bar B by elevating and lowering the print bar B. As shown in FIG. 5, the elevation driver 11 includes an elevation holder 12 for holding the print bar B on the one side X1 and an elevation holder 13 for holding the print bar B on the other side X2.

If the holding unit 72 is located on the parts 711A of the guiding rails 71, the head unit 3 of the print bar B is located at a facing position L1 facing the web W being conveyed by the conveyor 2. On the other hand, if the holding unit 72 is located on the parts 711B of the guiding rails 71, the head unit 3 of the print bar B is retracted to a retracted position L2 on the other side X2 in the X direction from the facing position L1 and not facing the web W being conveyed by the conveyor 2. In this way, the holding unit 72 can selectively perform an operation of locating the head unit 3 at the facing position L1 and an operation of locating the head unit 3 at the retracted position L2 by moving in the X direction. Note that the holding unit 72 may be moved in the X direction manually or by a single-axis robot.

The holding frame 74 holds four ink returners 46 respectively corresponding to the four print bars B (in other words, the head units 3). As shown in FIG. 6, the ink returner 46 includes a bottom plate 463 for holding the circulation pump 462, the filter 51 and the deaeration module 61, and the bottom plate 463 is mounted on the holding frame 74.

One end of a pipe 461A (a part of the pipe 461) is attached to an input port 462I of the circulation pump 462, and the other end of the pipe 461A is connected to the collection tank 451 of the print bar B via a flexible pipe. This flexible pipe is held by a cable carrier 75 connected to the print bar B and the holding frame 74. Here, a cable bear (trademark) can be used as the cable carrier 75. The ink flowing into the input port 462I of the circulation pump 462 is driven by the circulation pump 462 and output from an output port 462O of the circulation pump 462.

The filter 51 includes a single housing 511 having a substantially cylindrical shape, a single inflow port 512 projecting upward from the upper end of the housing 511 and a single outflow port 513 projecting downward from the lower end of the housing 511. The output port 462O of the circulation pump 462 and the inflow port 512 of the filter 51 are connected by a pipe 461B (a part of the pipe 461), and the ink output from the output port 462O of the circulation pump 462 flows into the inflow port 512 via the pipe 461B. The ink flowing into the housing 511 from the inflow port 512 flows out from the outflow port 513 after having foreign matters removed by the filter 51.

The deaeration module 61 includes a single housing 611 having a substantially cylindrical shape, a single inflow port 612 projecting upward from the upper end of the housing 611 and a single outflow port 613 projecting laterally from the side wall of the housing 611. The hollow fiber membrane is stored in the housing 611. The output port 513 of the filter 51 and the inflow port 612 of the deaeration module 61 are connected by a pipe 461C (a part of the pipe 461), and the ink flowing out from the output port 513 of the filter 51 flows into the inflow port 612 via the pipe 461C. The ink flowing into the housing 611 from the inflow port 612 flows out from the outflow port 613 after passing through outside the hollow fiber membrane in the housing 611.

Further, the deaeration module 61 includes an exhaust port 614 projecting downward from the lower end of the housing 611. This exhaust port 614 is connected to the vacuum pump by a vacuum pipe 69, and a negative pressure generated by the vacuum pump is applied to the inside of the hollow fiber membrane in the housing 611 via the vacuum pipe 69 and the exhaust port 614. As a result, the gas is sucked and removed from the ink via the hollow fiber membrane.

One end of a pipe 461D (a part of the pipe 461) is attached to the outflow port 613 of the deaeration module 61, and the other end of the pipe 461D is connected to the supply tank 441 of the print bar B via a flexible pipe. This flexible pipe is held by the cable carrier 75 connected to the print bar B and the holding frame 74.

In the X direction, the circulation pump 462 and the deaeration module 61 are arranged at positions different from each other. That is, the deaeration module 61 is arranged on the other side X2 of the circulation pump 462. In a front view from the X direction, a lower end part (exhaust port 614) of the deaeration module 61 at least partially overlaps the circulation pump 462.

The filter 51 is adjacent to the deaeration module 61 in the Y direction. Further, the circulation pump 462 and the filter 51 are arranged at positions different from each other in the X direction. That is, the filter 51 is arranged on the other side X2 of the circulation pump 462. In a front view from the X direction, a lower end part (outflow port 513) of the filter 51 at least partially overlaps the circulation pump 462.

In the embodiment described above, the discharge heads 31 discharge the ink supplied from the supply tank 441. Accordingly, to maintain the discharge of the ink from the discharge heads 31 satisfactory, it is important to sufficiently suppress the quantity of the gas mixed in the ink in the supply tank 441 serving as a supply source of the ink to the discharge heads 31. On the other hand, the ink is supplied to the supply tank 441 via the collection tank 451, whereas the gas having entered the discharge head 31 via the nozzles 311 is easily mixed into the ink in the collection tank 451. Thus, in this embodiment, the deaeration module 61 (first deaeration unit) is arranged in the return pipe 461 (return flow channel) for returning the ink from the collection tank 451 to the supply tank 441, and this deaeration module 61 removes the gas from the ink, which flows in the pipe 461 and is likely to contain a lot of the gas. In this way, the gas is removed from the ink flowing out from the collection tank 451 toward the supply tank 441. Further, in this embodiment, the deaeration module 62 (second deaeration unit) is arranged in the pipe 471 (replenishment flow channel) for replenishing the ink from the buffer tank 42 (ink tank) to the collection tank 451, and this deaeration module 62 removes the gas from the ink flowing in the pipe 471. In this way, the gas is removed from the ink flowing toward the collection tank 451. That is, in this embodiment, the deaeration modules 61, 62 are respectively provided for the entrance and exit of the collection tank 451, through which the ink passes immediately before flowing into the supply tank 441. As a result, the discharge of the ink from the discharge heads 31 can be maintained satisfactory by sufficiently suppressing the quantity of the gas mixed in the ink in the supply tank 441 serving as the supply source of the ink to the discharge heads 31.

Further, the conveyor 2 configured to convey the web W (printing medium) and the holding unit 72 (head holding unit) movable in the X direction (movable direction) and configured to hold the head unit 3 are provided. By moving in the X direction, the holding unit 72 moves the head unit 3 between the facing position L1 facing the web W being conveyed by the conveyor 2 and the retracted position L2 retracted from the facing position L1 in the X direction. In contrast, the deaeration module 61 is held by the holding unit 72 and moves integrally with the holding unit 72. That is, the head unit 3 may be appropriately moved in the X direction for maintenance or the like. In contrast, the deaeration module 61 provided immediately before the supply tank 441 serving as the supply source of the ink to the discharge heads 31 is arranged relatively close to the head unit 3. Thus, a possibility that the deaeration module 61 interferes with a movement of the head unit 3 is supposed. Accordingly, in this embodiment, the holding unit 72 for movably holding the head unit 3 is provided, and the deaeration module 61 is held by this holding unit 72 and moves integrally with the holding unit 72. Therefore, the interference of the deaeration module 61 with a movement of the head unit 3 can be prevented while the deaeration module 61 is arranged relatively close to the head unit 3.

Further, the number of deaeration modules 61 held by the holding unit 72 is one. In such a configuration, the size of a moving body including the head unit 3, the holding unit 72 and the deaeration module 61 can be suppressed and the complication of apparatus configuration can be suppressed.

Further, the deaeration module 62 is provided separately from the holding unit 72. That is, the deaeration module 62 needs not necessarily be arranged close to the head unit 3. Accordingly, the size of the moving body can be suppressed by providing the deaeration module 62 separately from the holding unit 72.

Further, the ink returner 46 includes the circulation pump 462 (pump), which is arranged in the pipe 461 (return flow channel) and drives the ink in the pipe 461 from the collection tank 451 to the supply tank 441. This circulation pump 462 is held by the holding unit 72 and moves integrally with the holding unit 72. In such a configuration, the interference of the circulation pump 462 with a movement of the head unit 3 can be prevented while the circulation pump 462 is arranged relatively close to the head unit 3.

Further, the circulation pump 462 and the deaeration module 61 are arranged on the holding unit 72 while being shifted from each other in the X direction. In such a configuration, the circulation pump 462 and the deaeration module 61 can be compactly arranged in the Y direction (width direction) orthogonal to the X direction. As a result, a width of the ink-jet printing apparatus 1 can be suppressed.

In the embodiment described above, the nozzle 311 corresponds to an example of a “nozzle” of the invention, the discharge head 31 corresponds to an example of a “discharge head” of the invention, the head unit 3 corresponds to an example of a “head unit” of the invention, the supply tank 441 corresponds to an example of a “supply tank” of the invention, the collection tank 451 corresponds to an example of a “collection tank” of the invention, the pipe 461 corresponds to an example of a “return flow channel” of the invention, the ink returner 46 corresponds to an example of an “ink returner” of the invention, the buffer tank 42 corresponds to an example of an “ink tank” of the invention, the pipe 471 corresponds to an example of a “replenishment flow channel” of the invention, the ink replenisher 47 corresponds to an example of an “ink replenisher” of the invention, the deaeration module 61 corresponds to an example of a “first deaeration unit” of the invention, the deaeration module 62 corresponds to an example of a “second deaeration unit” of the invention, the ink-jet printing apparatus 1 corresponds to an example of an “ink-jet printing apparatus” of the invention, the web W corresponds to an example of a “printing medium” of the invention, the conveyor 2 corresponds to an example of a “conveyor” of the invention, the X direction corresponds to an example of a “movable direction” of the invention, the holding unit 72 corresponds to an example of a “head holding unit” of the invention, the facing position L1 corresponds to an example of a “facing position” of the invention, the retraced position L2 corresponds to an example of a “retracted position” of the invention, and the circulation pump 462 corresponds to an example of a “pump” of the invention.

Note that the invention is not limited to the above embodiment and various changes other than the aforementioned ones can be made without departing from the gist of the invention. For example, the specific configuration of the deaeration module 61 is not limited to the above example. Therefore, a deaeration module configured such that an ink passes through the inside of a hollow fiber filter and is sucked outside the hollow fiber filter can be used as the deaeration module 61. The same applies also to the deaeration module 62.

Further, an arrangement relationship of the print bar B and the ink returner 46 is not limited to the example of FIG. 5 and it is not essential that the ink returner 46 can move integrally with the print bar B. Further, an arrangement relationship of the circulation pump 462 and the deaeration module 61 is not limited to the example of FIG. 6 and a positional relationship of these can be changed as appropriate.

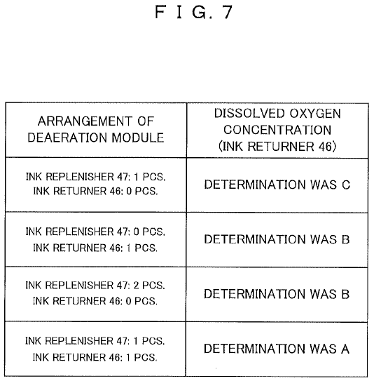

FIG. 7 is a table showing an example of an experimental result on a relationship of the arrangement of the deaeration modules and a dissolved oxygen concentration in the ink returner. That is, in FIG. 7, a column “Arrangement of Deaeration Modules” shows the numbers of the deaeration modules arranged in the ink replenisher 47 and the ink returner 46, and a column “Dissolved Oxygen Concentration” shows a result of determining the dissolved oxygen concentration in the ink returner 46 based on a predetermined reference.

In an example in which one deaeration module 61 was arranged in the ink replenisher 47 and no deaeration module was arranged in the ink returner 46, the dissolved oxygen concentration in the ink returner 46 was high and determination was C. In an example in which no deaeration module was arranged in the ink replenisher 47 and one deaeration module was arranged in the ink returner 46, the dissolved oxygen concentration in the ink returner 46 was middle and determination was B. In an example in which two deaeration modules 61 were arranged in the ink replenisher 47 and no deaeration module was arranged in the ink returner 46, the dissolved oxygen concentration in the ink returner 46 was middle and determination was B. In an example in which one deaeration module 61 was arranged in the ink replenisher 47 and one deaeration module was arranged in the ink returner 46, the dissolved oxygen concentration in the ink returner 46 was low and determination was A.

That is, it was found that the dissolved oxygen concentration in the ink returner 46 could be suppressed low and a satisfactory result was obtained by arranging one deaeration module 61 in the ink replenisher 47 and arranging one deaeration module in the ink returner 46.

The invention is applicable to deaeration techniques in general for removing a gas from an ink to be supplied to a discharge head for discharging the ink from nozzles.

The ink-jet printing apparatus may further comprises: a conveyor conveying a printing medium; and a head holding unit movable in a predetermined movable direction, the head holding unit holding the head unit, wherein: the head holding unit moves the head unit between a facing position facing the printing medium being conveyed by the conveyor and a retracted position retracted from the facing position in the movable direction by moving in the movable direction, and the first deaeration unit is held by the head holding unit and moves integrally with the head holding unit. That is, the head unit may be appropriately moved for maintenance or the like. In contrast, the first deaeration unit provided immediately before the supply tank serving as the supply source of the ink to the discharge head is arranged relatively close to the head unit. Thus, a possibility that the first deaeration unit interferes with a movement of the head unit is supposed. Accordingly, in the above configuration, the head holding unit for movably holding the head unit is provided, and the first deaeration unit is held by this head holding unit and moves integrally with the head holding unit. Therefore, the interference of the first deaeration unit with a movement of the head unit can be prevented while the first deaeration unit is arranged relatively close to the head unit.

The ink-jet printing apparatus may be configured so that a number of the first deaeration unit held by the head holding unit is one. In such a configuration, the size of a moving body including the head unit, the head holding unit and the first deaeration unit can be suppressed and the complication of apparatus configuration can be suppressed.

The ink-jet printing apparatus may be configured so that the second deaeration unit is provided separately from the head holding unit. That is, the second deaeration unit needs not necessarily be arranged close to the head unit. Therefore, the size of the moving body can be suppressed by providing the second deaeration unit separately from the head holding unit.

The ink-jet printing apparatus may be configured so that the ink returner includes a pump, which is arranged in the return flow channel and drives the ink in the return flow channel from the collection tank to the supply tank, and the pump is held by the head holding unit and moves integrally with the head holding unit. In such a configuration, the interference of the pump with a movement of the head unit can be prevented while the pump is arranged relatively close to the head unit.

The ink-jet printing apparatus may be configured so that the pump and the first deaeration unit are shifted from each other in the movable direction and arranged on the head holding unit. In such a configuration, the pump and the first deaeration unit can be compactly arranged in a width direction orthogonal to the movable direction. As a result, a width of the ink-jet printing apparatus can be suppressed.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. An ink-jet printing apparatus, comprising:
a head unit including a discharge head discharging an ink from nozzles;
a supply tank supplying the ink to the discharge head;
a collection tank collecting the ink from the discharge head;
an ink returner including a return flow channel connecting the collection tank and the supply tank, the ink returner returning the ink from the collection tank to the supply tank by the return flow channel;
an ink tank storing the ink; and
an ink replenisher including a replenishment flow channel connecting the ink tank and the collection tank, the ink replenisher replenishing the ink from the ink tank to the collection tank by the replenishment flow channel,
the ink returner including a first deaeration unit arranged in the return flow channel,
the first deaeration unit removing a gas from the ink flowing in the return flow channel,
the ink replenisher including a second deaeration unit arranged in the replenishment flow channel, and
the second deaeration unit removing the gas from the ink flowing the replenishment flow channel.

2. The ink-jet printing apparatus according to claim 1, further comprising:
a conveyor conveying a printing medium; and
a head holding unit movable in a predetermined movable direction, the head holding unit holding the head unit,
wherein:
the head holding unit moves the head unit between a facing position facing the printing medium being conveyed by the conveyor and a retracted position retracted from the facing position in the movable direction by moving in the movable direction, and
the first deaeration unit is held by the head holding unit and moves integrally with the head holding unit.

3. The ink-jet printing apparatus according to claim 2, wherein:
a number of the first deaeration unit held by the head holding unit is one.

4. The ink-jet printing apparatus according to claim 2, wherein:
the second deaeration unit is provided separately from the head holding unit.

5. The ink-jet printing apparatus according to claim 2, wherein:
the ink returner includes a pump, which is arranged in the return flow channel and drives the ink in the return flow channel from the collection tank to the supply tank, and
the pump is held by the head holding unit and moves integrally with the head holding unit.

6. The ink-jet printing apparatus according to claim 5, wherein the pump and the first deaeration unit are shifted from each other in the movable direction and arranged on the head holding unit.

7. An ink deaeration method, comprising:
supplying an ink from a supply tank to a discharge head discharging the ink from nozzles;
collecting the ink from the discharge head to the collection tank;
returning the ink from the collection tank to the supply tank by a return flow channel connecting the collection tank and the supply tank;
replenishing the ink from the ink tank to the collection tank by a replenishment flow channel connecting the ink tank and the collection tank,
a first deaeration unit being arranged in the return flow channel,
the first deaeration unit removing a gas from the ink flowing in the return flow channel,
a second deaeration unit being arranged in the replenishment flow channel, and
the second deaeration unit removing the gas from the ink flowing in the replenishment flow channel.
